(19) United States
(12) Patent Application Publication
(10) Pub. No.: US 2015/0194256 A1
(43) Pub. Date: Jul. 9, 2015

(54) MAGNETIC COUPLING INDUCTOR AND MULTI-PORT CONVERTER

(71) Applicant: TOYOTA JIDOSHA KABUSHIKI KAISHA, Toyota-shi (JP)

(72) Inventors: Kenichi TAKAGI, Nagakute-shi (JP); Masanori ISHIGAKI, Nagakute-shi (JP); Takahide SUGIYAMA, Nagakute-shi (JP); Takaji UMENO, Nagakute-shi (JP); Kenichiro NAGASHITA, Toyota-shi (JP); Takahiro HIRANO, Toyota-shi (JP); Jun MUTO, Toyota-shi (JP)

(73) Assignee: TOYOTA JIDOSHA KABUSHIKI KAISHA, Toyota-shi (JP)

(21) Appl. No.: 14/566,042

(22) Filed: Dec. 10, 2014

(30) Foreign Application Priority Data
Dec. 11, 2013 (JP) 2013-255886

(51) Int. Cl. H01F 27/28; H02M 3/335

(52) U.S. Cl. CPC H01F 27/2804; H02M 3/33507; H01F 2027/2809

(57) ABSTRACT

A magnetic coupling inductor includes a pair of windings that are magnetically coupled. A same phase current and a reverse phase current both flow through the pair of windings, and each winding has a plurality of turns in one layer in the axial direction of the windings. The windings through which the currents of opposite phases flow of the one layer of the pair of windings are oppositely arranged to each other in the axial direction of the windings.

### INCORPORATION BY REFERENCE

The disclosure of Japanese Patent Application No. 2013-255886 filed on Dec. 11, 2013 including the specification, drawings and abstract is incorporated herein by reference in its entirety.

### BACKGROUND OF THE INVENTION

1. Field of the Invention

The present invention relates to a magnetic coupling inductor having a pair of windings that are magnetically coupled and through which a same phase current and a reverse phase current both flow, and a multi-port converter using the magnetic coupling inductor.

2. Description of Related Art

Various electric devices such as a drive motor, an air conditioner motor, an electric power steering (EPS), and other various auxiliary mechanisms that operate by using electricity are mounted in an electric vehicle and a hybrid vehicle. It is necessary to provide a plurality of power supplies having different operating voltages or currents suitable for these devices in correspondence with outputs of these devices.

When a battery of about 300V is provided as a drive battery, in order to obtain a DC voltage of a suitable voltage, (i) a step-up converter for driving the drive motor, (ii) a DC/DC converter for supplying power to the auxiliary mechanisms, and (iii) a DC/DC converter for driving the EPS and so on are required. Further, a circuit for charging an internal power supply with an AC current from an external AC power supply, an inverter for driving an AC driven device mounted in a vehicle and so on are also required.

In Japanese Patent Application Publication No. 2012-125040 (JP 2012-125040), it is described that these two functions of the step-up converter and the insulation converter are achieved by causing two currents to flow in a first winding of one transformer. That is by connecting a pair of midpoints of a full bridge circuit across the first winding, a desired AC current is caused to flow through the first winding, so that it operates as the insulation converter. Further, a pair of windings of a magnetic coupling inductor are respectively provided between the pair of midpoints of the full bridge circuit and the ends of the first winding. Further, a first power supply is connected to both bus lines of the full bridge circuit, and a second power supply is connected between a midpoint of the first winding and a negative side bus line of the full bridge circuit.

In this way, by switching of the full bridge circuit, an predetermined AC current is caused to flow through the first winding, whereas a predetermined alternating current is obtained in a second winding. Further, by turning on/off a current flowing downward from the midpoint of the first winding, it is possible to produce a current flowing to a positive side bus line of the full bridge circuit using the magnetic coupling inductor, so that it functions as the step-up converter.

Here, when the circuit of JP 2012-125040 is actually used, a large amount of heat may be generated in the magnetic coupling inductor. Not only the current as an insulation converter but also the current as the step-up converter flows through the magnetic coupling inductor. Since the current caused by operation of the step-up converter flows in the same direction with respect to winding conductors, the magnetic flux may not be enhanced by the current flowing through the windings. On the other hand, the current caused by operation of the insulation converter flows in an opposite direction with respect to the winding conductors. Thus a mutual enhancement of the magnetic fluxes occurs between the conductors. Joule heat is generated by the magnetic fluxes mutually enhanced between the conductors by interconnecting to the conductors, and such generated heat not only degrades the material but also leads to inefficiency.

### SUMMARY OF THE INVENTION

An aspect of the invention is a magnetic coupling inductor having a pair of windings that are magnetically coupled, each winding having a plurality of turns in one layer of a plurality of layers stacked in an axial direction of the windings, the windings of the pair of windings being oppositely arranged to each other in the axial direction of the windings.

The magnetic coupling inductor having the pair of windings that are magnetically coupled may also cause a same phase current and a reverse phase current both to flow through the pair of windings, each winding may have a plurality of turns in one layer in the axial direction of the windings, and the windings through which the currents of opposite phases flow of the one layer of the pair of windings may be oppositely arranged to each other in the axial direction of the windings.

Another aspect of the invention is a multi-port converter having a pair of windings that are magnetically coupled and a transformer, each winding having a plurality of turns in one layer of a plurality of layers of the pair of windings stacked in an axial direction of the windings, the windings of the pair of windings being oppositely arranged to each other in the axial direction of the windings, wherein, at least three connection terminals including a pair of both sides terminals and at least one intermediate terminal are provided on one side winding of the transformer, a first power supply is connected to the both sides terminals via each winding of a magnetic coupling inductor having the pair of windings that are magnetically coupled, a second power supply is connected between one of the both sides terminals and the intermediate terminal, and power is exchanged between the one side winding of the transformer and the other side winding of the transformer that is magnetically coupled with the one side winding of the transformer.

Further, the multi-port converter may also provide at least three connection terminals including a pair of both sides terminals and at least one intermediate terminal on one side winding of the transformer, a first power supply being connected to the both sides terminals via each winding of a magnetic coupling inductor having a pair of windings that are magnetically coupled, a second power supply being connected between one of the both sides terminals and the intermediate terminal, and power being exchanged between the one side winding and the other side winding that is magnetically coupled with the one side winding, wherein, the magnetic coupling inductor causes a same phase current flowing through the one side winding and a reverse phase current flowing through the intermediate terminal of the one side winding both to flow through the pair of windings, each winding has a plurality of turns in one layer in the axial direction of the windings, and the windings through which the currents of opposite phases flow of the one layer of the pair of windings are oppositely arranged to each other in the axial direction of the windings.

Further, in one embodiment, the pair of windings of the magnetic coupling inductor are only a single layer respectively.

In accordance with the present invention, it is possible to suppress the Joule loss in the magnetic coupling inductor.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing an overall configuration of a system;

FIG. 2A is a diagram illustrating a function of an insulation converter;

FIG. 2B is a diagram illustrating a function of a step-up converter;

FIG. 3 is a diagram illustrating a configuration of a magnetic coupling inductor;

FIG. 4A is a diagram showing a magnetic field generated by a current flowing through the magnetic coupling inductor;

FIG. 4B is a diagram showing the magnetic field generated by the current flowing through the magnetic coupling inductor;

FIG. 5A is a diagram showing a state of a magnetic flux density distribution in the magnetic coupling inductor;

FIG. 5B is a diagram showing a state of a Joule loss in the magnetic coupling inductor;

FIG. 6 is a diagram illustrating a configuration of a magnetic coupling inductor of an embodiment;

FIG. 7 is a diagram illustrating the configuration of the magnetic coupling inductor of the embodiment;

FIG. 8A is a diagram showing a state of a magnetic flux density distribution in the magnetic coupling inductor of the embodiment;

FIG. 8B is a diagram showing a state of a Joule loss in the magnetic coupling inductor of the embodiment;

FIG. 9 is a diagram showing the Joule loss in the magnetic coupling inductor of the embodiment;

FIG. 10 is a diagram illustrating a configuration of a modification of the magnetic coupling inductor of the embodiment;

FIG. 11 is a diagram illustrating a configuration of another modification of the magnetic coupling inductor of the embodiment; and

FIG. 12 is a diagram illustrating a configuration of yet another modification of the magnetic coupling inductor of the embodiment

### DETAILED DESCRIPTION OF EMBODIMENTS

An embodiment of the present invention will be described below on basis of the drawings. Further, the invention is not intended to be limited to the embodiment set forth herein.

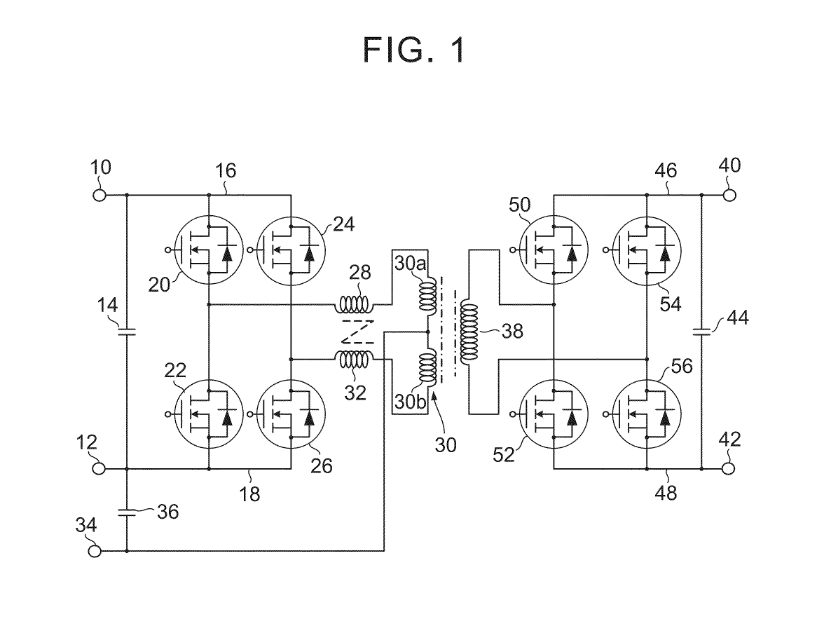

In FIG. 1, a multi-port converter system is shown, which has two ports on one side of a transformer and one port on the other side of the transformer and the multi-port converter system functions as a step-up converter between the two ports on the one side and the multi-port converter system functions as an insulation converter that operates as a transformer between one port of the one side and the other side. The number of the ports may be further increased. Even in this case, desired power can be exchanged between the ports on basis of the same principle as the system shown.

Firstly, a port A has a pair of terminals 10 and 12 between which a capacitor 14 is provided. A positive side bus line 16 is connected to the terminal 10 and a negative side bus line 18 is connected to the terminal 12. Moreover, a series connection of switching elements 20 and 22 and a series connection of switching elements 24 and 26 are provided between the positive side bus line 16 and the negative side bus line 18. The connection point of the switching elements 20 and 22 is connected to one end of a first winding 30 of the transformer via a magnetic coupling inductor 28, and the connection point of the switching elements 24 and 26 is connected to the other end of the first winding 30 of the transformer via a magnetic coupling inductor 32.

The first winding 30 of the transformer is configured of a series connection of windings 30a and 30b, and the connection point of the windings 30a and 30b is connected to a terminal 34 of a port C. The port C is formed between the terminal 34 and the terminal 12 of the port A, and a capacitor 36 is provided between the terminals 34 and 12.

A port B is connected to a second winding 38 of the transformer, and the port B has a pair of terminals 40 and 42. A capacitor 44 is provided between the terminals 40 and 42. The terminal 40 is connected to a positive side bus line 46, and the terminal 42 is connected to the negative side bus line 48. Moreover, a series connection of switching elements 50 and 52 and a series connection of switching elements 54 and 56 is provided between the positive side bus line 46 and the negative side bus line 48. The connection point of the switching elements 50 and 52 is connected to one end of the second winding 38 of the transformer, and the connection point of the switching elements 54 and 56 is connected to the other end of the second winding 38 of the transformer. Further, the switching elements 20, 22, 24, 26, 50, 52, 54, 56 respectively have a diode causing current flow to the positive side from the negative side that is connected in parallel to a transistor. Further, the first winding 30 and the second winding 38 are magnetically coupled by, for example, sharing a core, and function as a transformer.

### Function as an Insulation Converter

Firstly, a function as an insulation converter between the port A and the port B will be described briefly. When an AC current is caused to flow through the first winding 30 by controlling switching of switching elements 20 to 26, an AC current corresponding to this AC current flows through the second winding 38. Since a current is supplied only to the positive side bus line 46 from the negative side bus line 48 by respective diodes of the switching elements 50 to 56 across the second winding 38, a rectified DC voltage is obtained on the port B.

In the case of transmitting power to the port A from the port B, by causing a predetermined alternating current to flow through the second winding 38 using switching elements 50 to 56, a corresponding alternating current flows through the first winding 30, and desired DC power is obtained on the port A by rectifying with the diodes of the switching elements 20 to 26.

Here, in the case of causing an AC current to flow through the first winding 30 as a whole, currents of opposite phases flow through the magnetic coupling inductors 28 and 32. Thus, the magnetic coupling inductors 28 and 32 are coupled in opposite phases, and the function of the magnetic coupling inductors 28 and 32 become to be disabled.

Herein, in the present embodiment, the current flowing through the second winding can be controlled using the switching elements 50 to 56. Therefore, power may also be transmitted to the port A from the port B. Moreover, by controlling a phase difference of the AC currents flowing through the first winding 30 and the second winding 38, it is possible to control power phase bidirectionally. For example, it is possible to cause the port A to be 46V and cause the port B to be 288V.

### Function as a Step-Up Converter

Next, a function as a step-up converter between the port C and the port A will be described briefly. For example, the port C is about 12V, and with respect to the terminal 12, the terminal 34 is about +12V.

If the switching element 26 is turned on, a current flows to the terminal 12 from the terminal 34 of the port C through the winding 30b, the magnetic coupling inductor 32 and the switching element 26. Since the magnetic coupling inductors 32 and 28 are magnetically coupled, the same current flows through the magnetic coupling inductor 28, and energy is accumulated in the magnetic coupling inductor 28. Then, by turning off the switching element 26, the energy accumulated in the magnetic coupling inductor 28 flows to the positive side bus line 16 through the diode of the switching element 20 to charge the capacitor 14. When the switching element 22 is turned on, the energy accumulated in the magnetic coupling inductor 32 charges the capacitor 14 through the diode of the switching element 24 after the switching element 22 is turned off.

Here, in the case of causing the step-up converter to function, currents of opposite phases flow in the windings 30a and 30b of the first winding 30. Therefore, the magnetic flux induced by the winding 30a and 30b of the first winding 30 is canceled, and the function of the transformer becomes to be disabled.

Further, the step-up circuit using the windings 30a and 30b becomes to be a full-bridge configuration having the switching elements 20 to 26, and it is possible to control a step-up ratio by controlling duty ratios during ON periods of the switching elements 20 and 24 on the upper side and the switching elements 22 and 26 on the lower side. This enable to obtain a voltage of about 46V that has been stepped up on the port A with respect to the port C of 12V.

### Overall Operation

The system achieves the function as an insulation converter and the function as the step-up converter of the above at the same time. That is, the function as an insulation converter and the function as the step-up converter of the above are achieved by controlling the duty ratios and the phase differences of the switching elements 20 to 26 and 50 to 56. Since it is described in JP 2012-125040, Japanese Patent Application Publication No. 2009-284647 (JP 2009-284647) and so on, these details are omitted.

### Analysis of Heat Generation

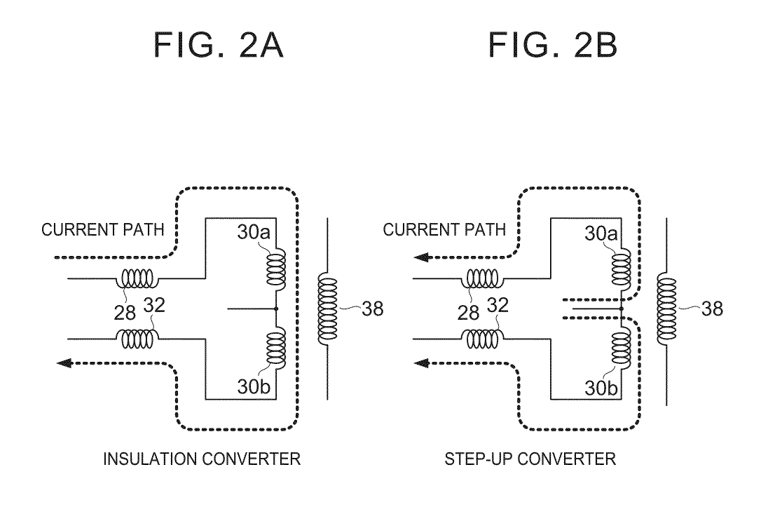

As mentioned above, in the present embodiment, the magnetic coupling inductors 28 and 32 are disabled for the function of the insulation converter, and are provided for function of the step-up converter. However, in these magnetic coupling inductors 28 and 32, in addition to the same phase current as the function of the step-up converter, the reverse phase current also flows for the function of the insulation converter. That is, in the case of the function of the step-up converter, as shown in FIG. 2B, the currents flowing through the windings 30a and 30b are in opposite phases, and the currents flowing through the magnetic coupling inductors 28 and 32 are in same phase. On the other hand, if it functions as an insulation converter, as shown in FIG. 2A, the currents flowing through the windings 30a and 30b are in same phase, and the currents flowing through the magnetic coupling inductors 28 and 32 are in opposite phases.

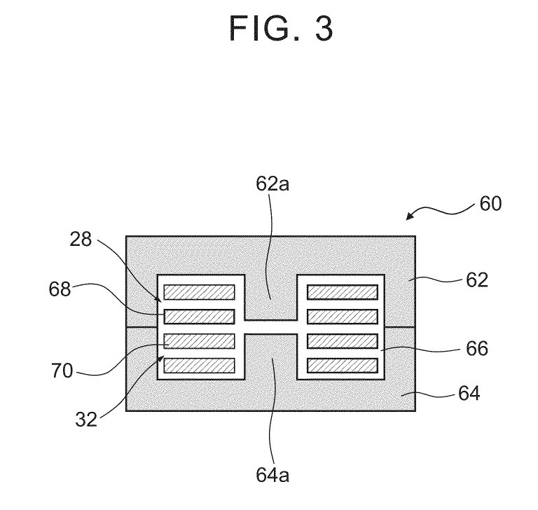

Here, the magnetic coupling inductors 28 and 32 are generally formed using a common magnetic core. Normally, as shown in FIG. 3, the magnetic coupling inductors 28 and 32 are configured integrally as an inductor 60. A magnetic core 62 on the upper side has an E-shaped cross section, and has a projection portion 62a at the center. Moreover, a winding 68 is wound into a plurality of layers on the projection portion 62a, for example, to form the magnetic coupling inductor 28. A magnetic core 64 on the lower side has the same E-shaped cross section as that of the magnetic core 62 on the upper side, and has a projection portion 64a at the center, which is oppositely arranged to the projection portion 62a. Moreover, a winding 70 is wound into a plurality of layers on the projection portion 64a, for example, to form the magnetic coupling inductor 32. With this configuration, the magnetic coupling inductors 28 and 32 are magnetically coupled. It should be noted that the recesses of the magnetic cores 62 and 64 come together, so as to form a winding accommodating space 66 surrounding the projection portions 62a and 64a.

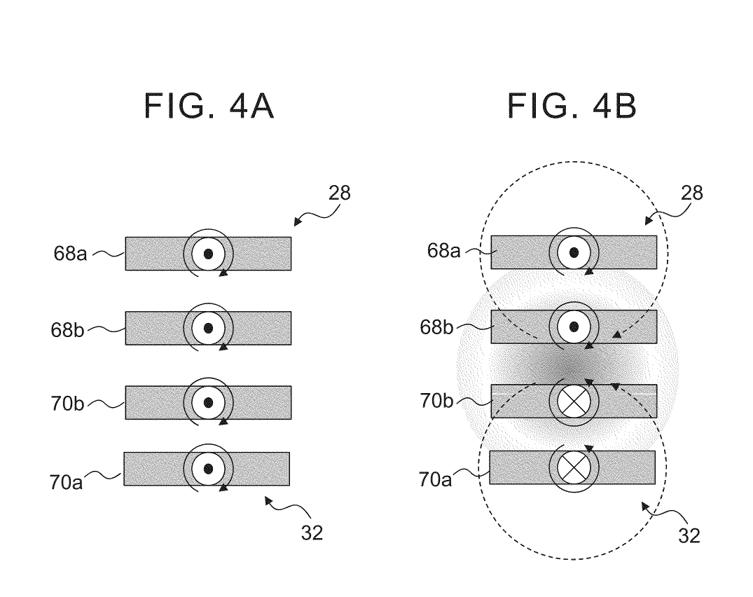

Here, if the currents flowing through the magnetic coupling inductors 28 and 32 are in same phase, the magnetic fluxes generated by adjacent windings are mutually canceled, thereby not being problematic, as shown in FIG. 4A.

However, in the present embodiment, in order to function as the insulation converter, the currents flowing through the magnetic coupling inductors 28 and 32 are in opposite phases. Thus, as shown in FIG. 4B, in the portion where the magnetic coupling inductors 28 and 32 (the windings 68 and 70) are oppositely arranged to each other, the magnetic fluxes are mutually enhanced. Therefore, in this portion, the magnetic flux density increases. Further, the windings 68 and 70 have a two-layer configuration respectively, and AC magnetic flux of outside winding 68a of the winding 68 and AC magnetic flux outside winding 70a of the winding 70 are interconnected with inside winding 68b of the winding 68 and inside winding 70b of the winding 70. Since the magnetic fluxes induced by the outside windings 68a and 70a are not mutually canceled, the magnetic fluxes are interconnected in the entire conductor of the inside windings 68b and 70b, so that a Joule loss occurs.

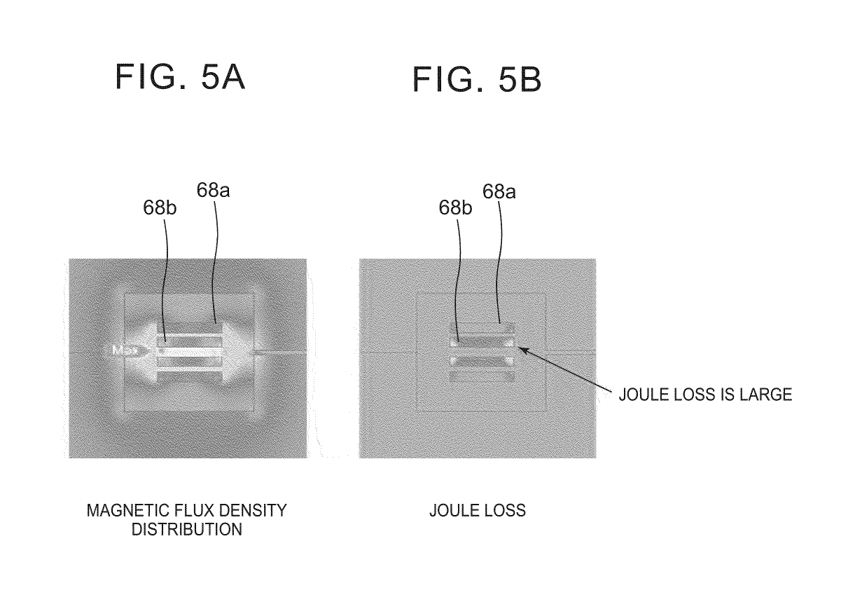

In FIG. 5A, a simulation result of the magnetic flux density distribution is shown. In this figure, bright place is where the magnetic flux density is large, and it can be seen that the magnetic flux density is large in the core portions oppositely arranged of the two magnetic coupling inductors 28 and 32. In FIG. 5(B), the Joule loss is shown. The place where it is different from the color of the background is where the Joule loss occurs, and with respect to the outside windings 68a and 70a the Joule loss only occurs in the right and left end portions. With respect to the inside windings 68b and 70b, the Joule loss occurs in the entire conductor, and the loss is larger in the right and left end portions.

In addition, FIG. 4 and FIG. 5 show only one side (the left side) of the windings 68 and 70 when showing in the cross sections of the magnetic coupling inductors 28 and 32.

It should be noted that the simulation is performed under the conditions that the battery voltage is ** V, the inductor current is ** A, and the winding radius is ** cm.

### Configuration of Embodiment

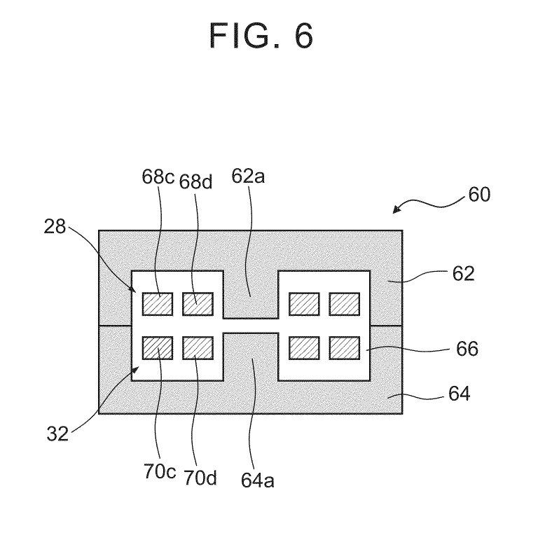

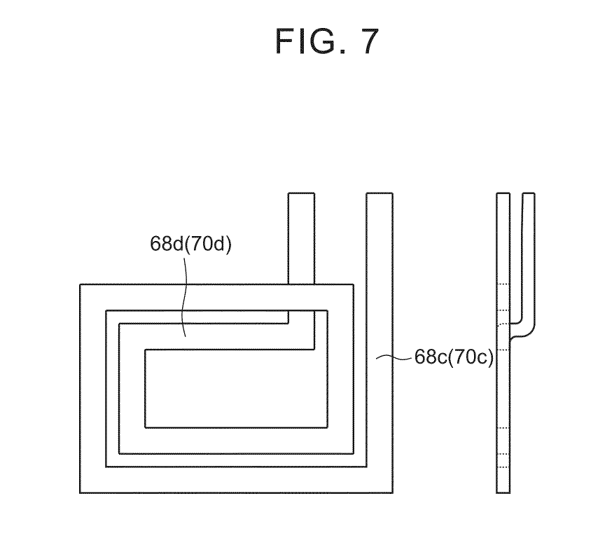

In the present embodiment, as shown schematically in FIG. 6 and FIG. 7, windings 68 and 70 function as one layer, a double spiral configuration of the outside windings 68c and 70c and the inside windings 68d and 70d in the one layer is obtained. That is, the windings 68 and 70, which are in the one layer, are wound helically (spirally) as mosquito coils, so that windings having a plurality of (two or more) windings (turns) in the one layer are obtained. Further, the cross sectional area and length of the winding are the same as those of the configuration of FIG. 3. This can result in that the windings 68 and 70 are oppositely arranged to each other, and the magnetic flux density increases in a portion where the windings 68 and 70 correspond to each other, so that the AC magnetic flux of the outside windings 68c and 70c located on the outside (in the axial direction of the windings) as viewed from the oppositely arranged surface is prevented from interconnecting in the inside windings 68d and 70d.

Further, if a plurality of turns of a winding can be provided in one layer, the influence of the magnetic flux of the outside windings 68c and 70c can be reduced, and thus the windings 68 and 70 are not necessarily limited to one layer. However, one layer is preferable because it can eliminate the influence of the outside windings. Further, in the figure, the windings have been described as square shaped, but they may also be circular shaped.

If a multiple spiral configuration of two or more spirals is provided, the windings that are adjacent in the right and left directions are in same phase and therefore the magnetic flux density does not increase, so that the influence of the outside windings in the axial direction of the windings can be reduced or eliminated.

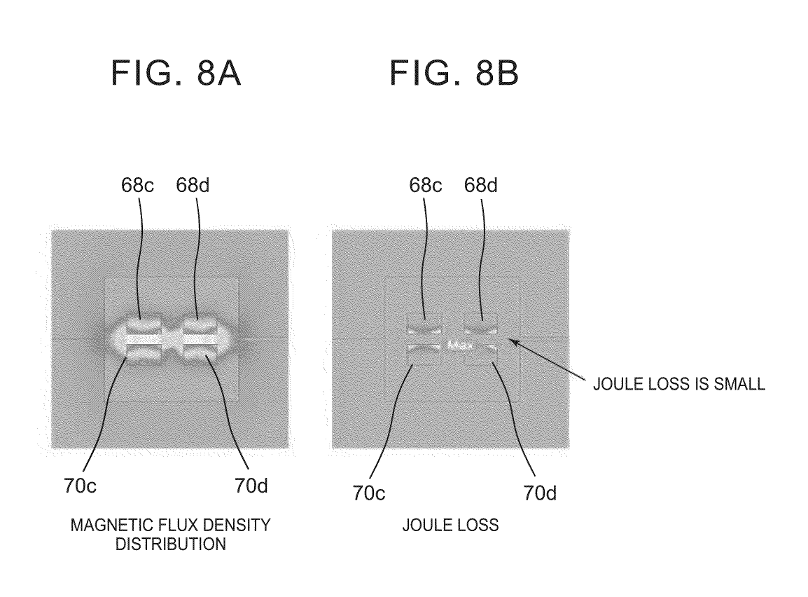

In FIG. 8, a simulation result of the magnetic flux density distribution and the Joule loss in the present embodiment is shown. Thus, in the region where the windings 68 and 70 are oppositely arranged to each other, the magnetic flux density becomes large. On the other hand, the Joule loss is limited to thin layers of the oppositely arranged sides of respective windings 68 and 70. The Joule loss becomes large in the portions on the right and left sides of respective windings 68 and 70, but this region is limited, and the Joule loss does not occur in the entire conductor.

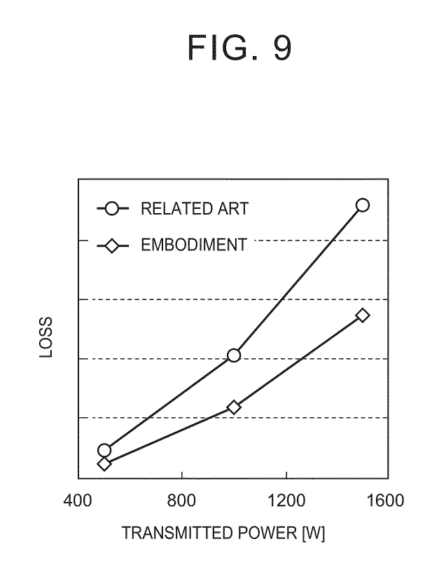

In FIG. 9, a relationship between the loss and the transmitted power is shown. It can be seen from this, as compared to the related art, it is possible to reduce the loss.

### Modification

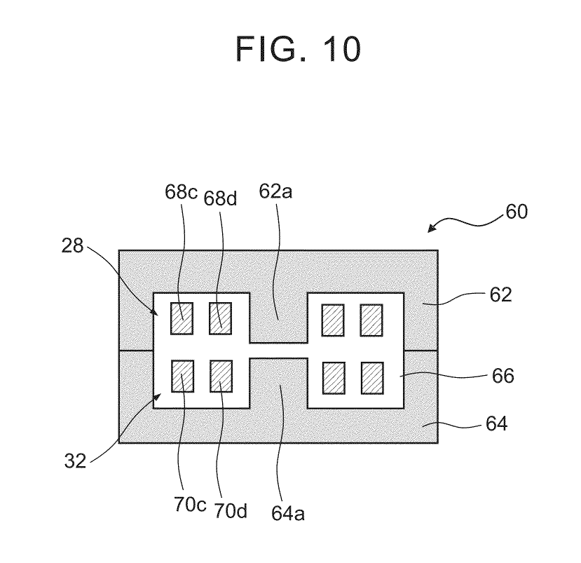

In FIG. 10, a modification of the present embodiment is shown. In this example, the sectional shape of the windings 68 and the sectional shape of the winding 70 are shapes elongated in the axial direction. By using such the shapes, the surface area of the surfaces that are oppositely arranged to each other of the conductors through which currents flow in opposite directions becomes small as compared to the surfaces of the conductors through which currents flow to the same direction (transverse direction), so that the AC magnetic flux interconnected to the windings can be effectively reduced.

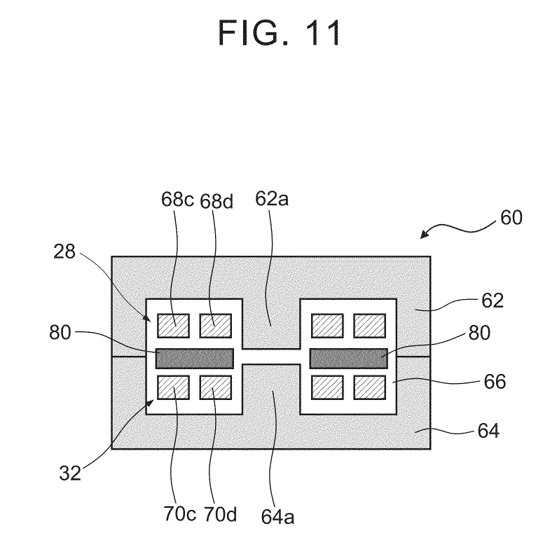

In FIG. 11, another modification of the present embodiment is shown. In this example, a spacer 80 is provided between the winding 68 and the winding 70. By providing the spacer 80 in this way, it is possible to increase the distance between the winding 68 and the winding 70, thereby reducing the AC magnetic flux interconnected to the windings 68c, 68d, 70c, 70d. However, it is necessary to consider not causing the coupling ratios between the magnetic coupling inductors 28 and 32 to degrade. Further, the spacer 80 is preferably formed of a non-magnetic material such as plastic.

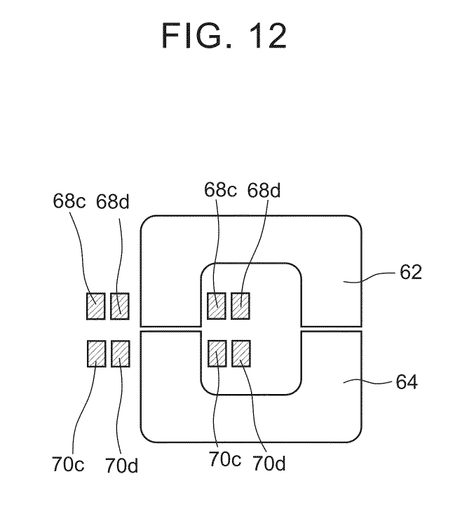

In FIG. 12, yet another embodiment is shown. In this example, a U-shaped core is used as the magnetic cores 62 and 64. Therefore, the windings 68c, 68d, 70c, 70d are wound around the edge of one of the magnetic cores 62 and 64. Even in the case of using such a U-core, it is possible to reduce the Joule loss using the spiral windings as well.

In this way, in the magnetic coupling inductors 28 and 32 of the present embodiment, the currents of opposite phases flow through both the magnetic coupling inductors 28 and 32, but by having a plurality of turns in the windings of one layer, the outside windings are not present as viewed in the axial direction of the windings or the outside windings become to be reduced as viewed in the axial direction of the windings, so that the AC magnetic flux induced by the outside windings are interconnected in the conductors of the inside windings, which can reduce the Joule loss generated in the conductors of the inside windings. By reducing the Joule loss, the power conversion efficiency of the insulation converter can be improved, thereby to facilitate to increase the operating frequency thereof, and miniaturization of the circuit can be expected by element derating.

Further, since it is possible to suppress the Joule loss, it is not necessary to use litz wires, which have small resistance, in the magnetic coupling inductors 28 and 32 so that the magnetic coupling inductors 28 and 32 may be obtained at low cost.

What is claimed is:

1. A magnetic coupling inductor, comprising:
a pair of windings that are magnetically coupled,
each winding having a plurality of turns in one layer of a plurality of layers stacked in an axial direction of the windings,
the windings of the pair of windings being oppositely arranged to each other in the axial direction of the windings.

2. The magnetic coupling inductor according to claim 1, wherein
a same phase current and a reverse phase current both flow through the pair of windings,
each winding having a plurality of turns in one layer of a plurality of layers stacked in the axial direction of the windings,
the windings through which the currents of opposite phases flow of the one layer of the pair of windings are oppositely arranged to each other in the axial direction of the windings.

3. The magnetic coupling inductor according to claim 1, wherein
the pair of windings of the magnetic coupling inductor are only a single layer, respectively.

4. The magnetic coupling inductor according to claim 1, wherein
the pair of windings have a shape elongated in the axial direction of the windings.

5. The magnetic coupling inductor according to claim 1, wherein
a spacer is provided between the pair of windings.

6. The magnetic coupling inductor according to claim 1, wherein
the magnetic coupling inductor has a U-shaped magnetic core.

7. A multi-port converter, comprising:
a pair of windings that are magnetically coupled, each winding having a plurality of turns in one layer of a plurality of layers stacked in an axial direction of the windings, the windings of the pair of windings being oppositely arranged to each other in the axial direction of the windings; and
a transformer, wherein,
at least three connection terminals are provided on one side winding of the transformer, the three connection terminals including a pair of both sides terminals and at least one intermediate terminal,
a first power supply is connected to the both sides terminals via each winding of a magnetic coupling inductor, the pair of windings being magnetically coupled, and
a second power supply is connected between one of the both sides terminals and the intermediate terminal,
power is exchanged between the one side winding of the transformer and the other side winding of the transformer, the other side winding of the transformer being magnetically coupled with the one side winding of the transformer.

8. The multi-port converter according to claim 7, wherein
a same phase current and a reverse phase current both flow through the pair of windings of the magnetic coupling inductor, wherein the same phase current is a current flowing through the one side winding of the transformer, and the reverse phase current is a current flowing through the intermediate terminal of the one side winding of the transformer,
each winding having a plurality of turns in one layer of a plurality of layers stacked in the axial direction of the windings,
the windings through which the currents of opposite phases flow of the one layer of the pair of windings are oppositely arranged to each other in the axial direction of the windings.

9. The multi-port converter according to claim 7, wherein
the pair of windings of the magnetic coupling inductor are only a single layer, respectively.

10. The multi-port converter according to claim 7, wherein
the pair of windings have a shape elongated in the axial direction of the windings.

11. The multi-port converter according to claim 7, wherein
a spacer is provided between the pair of windings.

12. The multi-port converter according to claim 7, wherein
the magnetic coupling inductor has a U-shaped magnetic core.
